(19) United States
(12) Patent Application Publication
(10) Pub. No.: US 2025/0361939 A1
(43) Pub. Date: Nov. 27, 2025

(54) VALVE

(71) Applicant: VAT Holding AG, Haag (CH)

(72) Inventor: Peter ZVOKELJ, Höchst (AT)

(73) Assignee: VAT Holding AG, Haag (CH)

(21) Appl. No.: 18/873,825

(22) PCT Filed: May 8, 2023
(86) PCT No.: PCT/EP2023/062094

§ 371 Date: Dec. 11, 2024

(30) Foreign Application Priority Data
Jun. 13, 2022 (DE) 10 2022 114 806.8

(51) Int. Cl. F16K 1/34; F16K 31/04; F16K 51/02

(52) U.S. Cl. CPC F16K 1/34; F16K 31/04; F16K 51/02

(57) ABSTRACT

A valve (1), in particular vacuum valve, for metering a volumetric flow through a flow opening (2), wherein the valve (1) has a valve plate (3) for closing the flow opening (2) in a closed position of the valve (1), and at least two valve rods (4, 5) which are in each case inherently elongate. The valve rods (4, 5) are fastened to the valve plate (3) at mutually spaced-apart locations, and at least one of the valve rods (4, 5) is driven in a linearly displaceable manner by a valve drive (6, 7) of the valve (1) so as to adjust the valve plate (3) between the closed position and a maximum open position. Here, the valve rods (4, 5) are designed with a different stiffness in terms of a deflection transverse to their respective longitudinal extent.

### CROSS-REFERENCE TO RELATED APPLICATIONS

This application is a 371 National Phase of PCT/EP2023/062094, filed May 8, 2023, which claims priority from German Patent Application No. 10 2022 114 806.8, filed Jun. 13, 2022, both of which are incorporated herein by reference as if fully set forth.

### TECHNICAL FIELD

The present invention relates to a valve, in particular a vacuum valve, for metering a volumetric flow through a flow opening, wherein the valve has a valve plate for closing the flow opening in a closed position of the valve, and at least two valve rods which are in each case inherently elongate, wherein the valve rods are fastened to the valve plate at mutually spaced-apart locations, and at least one of the valve rods is driven by a valve drive of the valve in a linearly displaceable manner so as to adjust the valve plate between the closed position and a maximum open position.

### BACKGROUND

Valves of this type are in particular used in vacuum technology for metering a volumetric flow, thus the inflow or the outflow of a fluid, in particular of a gas, through a flow opening. In most instances, these are flow openings through which an inflow or outflow of the fluid to or from a process chamber takes place. The volumetric flow through the flow opening can be well metered with such valves. A valve of this type is shown, for example, in FIGS. 5a and 5b of U.S. Pat. No. 10,156,299 B2.

Valves of this type are typically installed in such a way that the valve plate is located in the process chamber, and the valve drives are located outside the process chamber. There is usually a temperature difference prevalent between the region within the process chamber and the region outside the process chamber, so that the necessity to compensate for thermal deformations generated by the temperature difference is created, in particular without particles being created as a result, or the creation of particles being ideally avoided in the process.

### SUMMARY

It is an object of the invention to provide a solution for the above.

This is achieved by a valve having one or more of the features disclosed herein.

It is thus provided according to the invention that the valve rods are designed with a different stiffness in terms of a deflection transverse to their respective longitudinal extent.

With the invention, a temperature-related longitudinal elongation of the valve plate can be compensated for in that the valve rod which is less stiff in terms of a deflection transverse to its longitudinal extent is deflected to a greater degree than the valve rod which is stiffer in terms of a deflection transverse to its longitudinal extent. Owing to this fact, differences in the temperature-related longitudinal elongation in and outside the process chamber can be compensated for, without particles being generated as a result.

It is favorably provided that the valve rods are driven by their respective valve drives exclusively in a linearly displaceable manner.

The valve rods can fundamentally consist of different materials. It can also be provided that one of the valve rods consists of a first material and the other valve rod, or the other valve rods, consists of another material. However, preferred variants of the invention provide that the valve rods are formed from the same material, preferably steel. The valve rods preferably consist of a steel, in particular high-grade steel.

The different stiffnesses of the valve rods can thus be achieved by using different materials. However, it is preferably provided that the valve rods at least in regions have a different diameter.

Independently of how this is implemented, it is in any case provided in preferred design embodiments of the invention that the valve rod which is stiffer in terms of the deflection transverse to its longitudinal extent has a section modulus that is at least five times that of the other valve rod or, in other words, than the valve rod which is less stiff in terms of the deflection transverse to its longitudinal extent.

The section modulus herein is a measure of the mechanical resistance that the respective valve rod exerts under load. In the present case, which relates to the deflection of the valve rods transverse to their respective longitudinal extent, the section modulus could also be referred to as an axial section modulus or a flexural modulus of resistance.

In the implementation of the invention, all linear valve drives which are known per se are in principle considered to be valve drives. Therefore, these can be hydraulic, pneumatic, or else electric valve drives. In preferred variants it is provided that each valve rod is driven by a dedicated valve drive of the valve. It is in turn favorable here when the valve drives of the valve rods are mutually synchronized. The synchronization can be implemented by an electronic, or controlled, coupling of the valve drives. In pneumatic and/or hydraulic valve drives, this can however also be implemented by corresponding hydraulic or pneumatic connecting lines.

In one group of implementations of the invention it can be provided that each of the valve rods is driven in a linearly displaceable manner by the respective valve drive on the entire adjustment path of the valve plate between the closed position and the maximum open position. In other words, it is provided in these variants that the valve rod which is stiffer in terms of a deflection transverse to its longitudinal extent, as well as the valve rod which is less stiff in terms of a deflection transverse to its longitudinal extent, are driven on the entire opening and closing path of the valve plate.

Deviating therefrom, it is however also possible that only the valve rod which is stiffer in terms of its deflection transverse to its longitudinal extent is driven in a linearly displaceable manner by its valve drive on the entire adjustment path of the valve plate between the closed position and the maximum open position.

In this instance, it is favorably provided in these variants that the valve rod which is less stiff in terms of its deflection transverse to its longitudinal extent is driven in a linearly displaceable manner by its valve drive only on a partial distance of the adjustment path of the valve plate toward the closed position and away from the closed position. This can be implemented, for example, in that the valve rod which is less stiff in terms of its deflection transverse to its longitudinal extent is decoupled from its valve drive on a partial distance of the adjustment path of the valve plate toward the maximum open position and away from the maximum open position. In such design embodiments of the invention, the linear drive for the less stiff valve rod is thus only active for pressing the valve plate onto the valve seat and/or for lifting the valve plate from the valve seat. The remainder of the movement of the valve plate is implemented exclusively by way of the valve drive of the stiffer valve rod.

In the context of a linguistic simplification, the valve rod which is stiffer in terms of the deflection transverse to its longitudinal extent can also be simply referred to in short as stiffer valve rod here. In the context of a linguistic simplification, the valve rod which is less stiff in terms of the deflection transverse to its longitudinal extent can also be simply referred to in short as less stiff valve rod here.

The flow opening is favorably surrounded by a valve seat onto which the valve plate is pressed when the latter in its closed position closes the flow opening. The valve seat can be part of the valve, or part of a valve seat plate which in turn is part of the valve. However, the valve seat could also be formed directly on a chamber wall of a process chamber.

### BRIEF DESCRIPTION OF THE DRAWINGS

Further features and details of preferred embodiments will be explained hereunder by way of example in the description of the figures in which:

FIGS. 1 to 11 show illustrations pertaining to a first exemplary embodiment of the invention;

FIGS. 12 to 22 show illustrations pertaining to a second exemplary embodiment of the invention;

FIGS. 23 to 26 show illustrations pertaining to a third exemplary embodiment of the invention;

FIGS. 27 to 30 show illustrations pertaining to a fourth exemplary embodiment of the invention;

FIGS. 31 to 34 show illustrations pertaining to a fifth exemplary embodiment of the invention; and

FIGS. 35 to 38 show illustrations pertaining to a sixth exemplary embodiment of the invention.

### DETAILED DESCRIPTION

Valves 1 according to the invention, as well as in the exemplary embodiments shown here, are preferably so-called vacuum valves. Vacuum valves are typically used when intending to operate in a special atmosphere and/or at a special pressure level. Vacuum valves are referred to in particular when operating at pressure differences of less than or equal to 0.001 mbar (millibar), or 0.1 Pascal. However, vacuum valves may also already be referred to when they are conceived for pressure differences below normal pressure, thus below 1 bar. All valves 1 shown in the exemplary embodiments here can be used as vacuum valves.

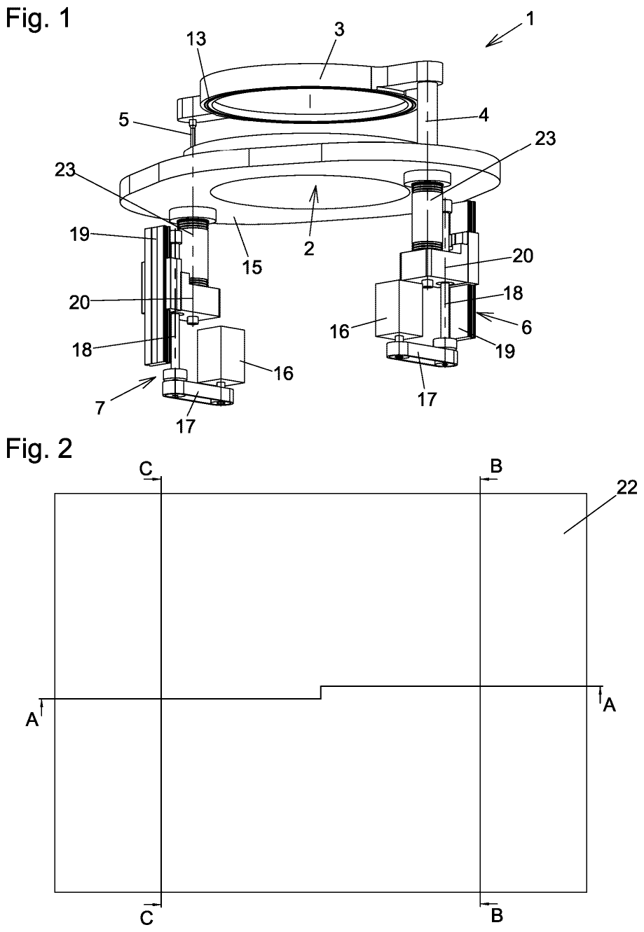

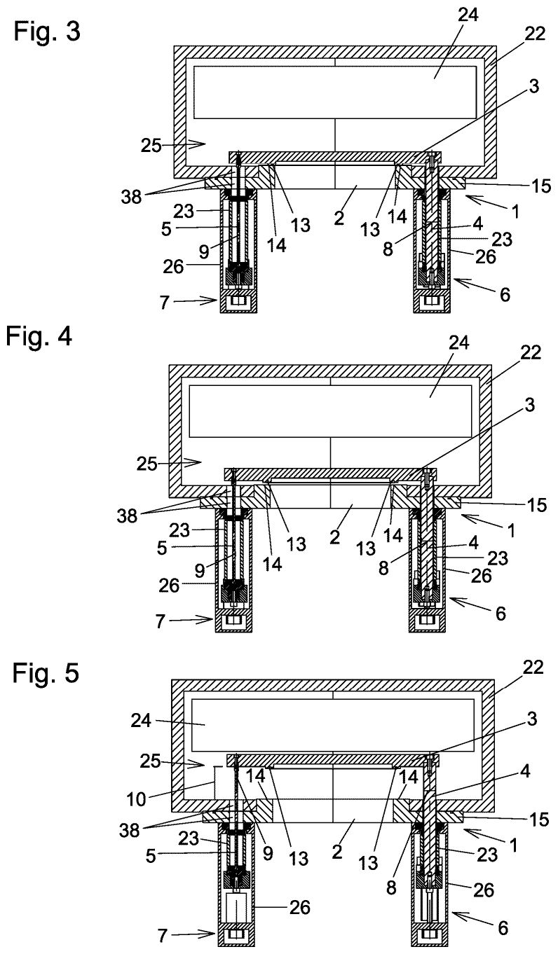

FIG. 1 now shows the valve 1 of the first exemplary embodiment, detached from the process chamber 22, in a perspective illustration, wherein the valve plate 3 is in the maximum open position. Two valve rods 4 and 5 are fastened to the valve plate 3. Each of the valve rods 4 and 5 is provided with a dedicated valve drive 6 and 7. The valve rods 4 and 5, and thus also the valve plate 3, can be displaced linearly in the longitudinal directions of the valve rods 4 and 5 by means of the valve drives 6 and 7. In this way, for closing the flow opening 2, the valve plate 3 can be moved to the closed position and just as well to the maximum open position and to the intermediate positions disposed therebetween, so as to meter the volumetric flow of fluid, either a gas or a liquid, flowing through the flow opening 2. In this exemplary embodiment, the flow opening 2 is formed here in a valve seat plate 15 and, as shown in FIGS. 3, 4 and 5, also in the corresponding process chamber 22. In the exemplary embodiment shown here, the valve seat 14 against which the valve plate 3 is pressed in the closed position is located in the valve seat plate 15. In this exemplary embodiment, the valve seat 14 and the valve seat plate 15 are thus part of the valve 1. However, it could just as well be provided that the valve seat plate 15 is dispensed with. In this instance, the valve seat 14 could be formed directly in a chamber wall of the process chamber 22 that surrounds the flow opening 2. In the exemplary embodiment shown, a seal 13 for sealing the flow opening 2 in the closed position of the valve plate 3 is located in the valve plate 3. However, corresponding seals 13 could of course also be implemented in the valve seat 14, or in the valve plate 3 as well as in the valve seat 14.

It is provided according to the invention that the valve rods 4 and 5 are designed with a different stiffness in terms of a deflection transverse to their respective longitudinal extent. In this exemplary embodiment here it is preferably provided that the valve rods 4 and 5 are formed from the same material, preferably from a steel or high-grade steel. In order to design the valve rods 4 and 5 with a different stiffness in terms of a deflection transverse to their respective longitudinal extent, it is presently provided in this exemplary embodiment that the valve rods 4 and 5 at least in regions have a different diameter 8 and 9. As already explained at the outset, it is favorable here that the valve rod 4 which is stiffer in terms of the deflection transverse to its longitudinal extent has a section modulus that is at least five times that of the other valve rod 5. Each of the valve rods 4 and 5 is driven by a dedicated valve drive 6 or 7 of the valve 1, respectively. In this first exemplary embodiment, the valve drives 6 and 7 for the two valve rods 4 and 5 are of an identical design. These are in each case spindle drives which are known per se. In this exemplary embodiment here it is in each case specifically implemented in such a way that the respective valve rod 4 and 5 at its end that faces away from the valve plate 3 is fastened to a slide 20, wherein this slide 20 is mounted so as to be linearly displaceable in each case on a guide rail 19. Each valve drive 6 and 7 has a dedicated motor, presently an electric motor 16. The respective electric motor 16 by way of a belt drive 17 drives in each case a spindle 18 in a manner which is known per se. A spindle nut 21 which engages in each case in the external thread of the spindle 18 is located in each case in the slide 20. In this way, the respective valve drive 6 or 7 by means of the respective motor 16 can displace the respective valve rod 4 and 5 in the direction parallel to its longitudinal extent along the respective guide rail 19. The rod seal 23, which surrounds the respective valve rod 4 and 5, ensures sealing in relation to the chamber interior 25. Corresponding rod seals 23 and spindle drives are known per se and need not be explained in more detail.

Of course, the type of the valve drives 6 and 7 implemented here could also be replaced by other suitable electric, pneumatic or hydraulic linear drives. It is in any case favorably provided that the valve drives 6 and 7 of the valve rods are mutually synchronized. In the present exemplary embodiment according to FIG. 1, this can be implemented, for example, by a corresponding electrical activation of the motors 16, which is not explicitly plotted here. In the case of pneumatic or hydraulic drives, this could also be implemented by a corresponding supply of pressure.

In this first exemplary embodiment, this is in any case a variant in which each of the valve rods 4 and 5 is driven by the respective valve drive 6 and 7, respectively, in a linearly displaceable manner on the entire adjustment path 10 of the valve plate 3 between the closed position and the maximum open position.

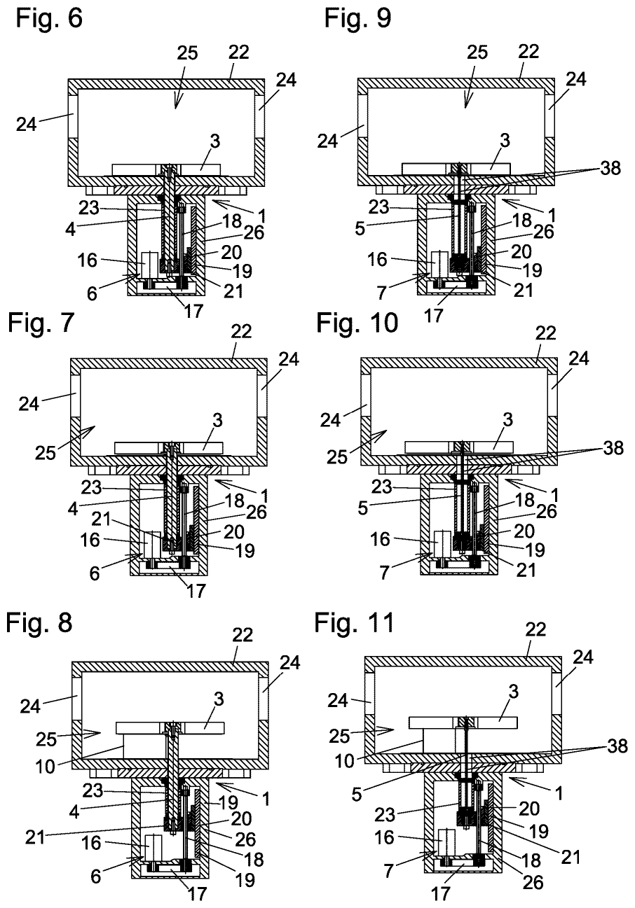

FIG. 2, pertaining to the first exemplary embodiment, now shows a top view of a schematically illustrated process chamber 22, the valve 1 from FIG. 1, which is correspondingly not visible in FIG. 2, being disposed on the lower side of said process chamber. In the top view according to FIG. 2, only the section lines AA, BB and CC are plotted. FIGS. 3 to 5 show sections along the section line AA, wherein the valve plate 3 of the valve 1 is in the closed position in FIG. 3, in an intermediate position in FIG. 4, and in a maximum open position in FIG. 5. FIGS. 6 to 8 show sections along the section line BB, wherein the valve plate 3 is again in the closed position in FIG. 6, in an intermediate position in FIG. 7, and in the maximum open position in FIG. 8. FIGS. 9 to 11 show sections along the section line CC, again with the valve plate 3 being in the closed position in FIG. 9, in an intermediate position in FIG. 10, and in the maximum open position in FIG. 11. It can be readily seen in FIGS. 3 to 5 that the diameter 8 of the stiffer valve rod 4 is significantly larger than the diameter 9 of the less stiff valve rod 5. Moreover, it can be readily seen that the valve drives 6 and 7 by way of their drive housings 26 are located outside the chamber interior 25 of the process chamber 22, while the valve plate 3 in all its positions is always disposed in the chamber interior 25. Typically, a different temperature level prevails in the chamber interior 25 than outside the process chamber 22. The valve plate 3 has the temperature of the chamber interior 25, while the valve drives 6 and 7 substantially have the temperature outside the process chamber 22. If the temperatures in the chamber interior 25 and in the process chamber 22 change relative to one another, longitudinal variations that are thermally caused arise in the valve plate 3, or else in the valve drives 6 and 7. These different temperature-related longitudinal elongations are compensated for according to the invention in that accordingly the less stiff valve rod 5 is deflected to some extent, preferably resiliently, transverse to its longitudinal extent. As a result, the temperature-related different expansions can be very well compensated for, without particles being generated. The feedthroughs 38 through the wall of the process chamber 22, and the optionally present valve seat plate 15, are favorably designed to be of such a size that there is corresponding amount of space available for the deflection of the valve rod 5. The rod seals 23 can readily compensate these deflections of the valve rod 5 which are thermally caused.

Seen in FIGS. 3 to 11 are also the introduction openings 24 through which objects to be processed can be introduced into the chamber interior 25 and can be retrieved from the process chamber 22. These introduction openings 24 can be closed by valves which are known per se and not illustrated here. As mentioned, the valve 1 for closing the flow opening 2 serves to meter a volumetric flow of a gaseous or liquid fluid which flows into the chamber interior 25 or out of the latter. Pumps and the like required for this purpose are not illustrated here but known per se.

While in this first exemplary embodiment according to FIGS. 1 to 11 both valve rods 4 and 5 are in each case driven by their respective valve drive 6 and 7 in a linearly displaceable manner on the entire adjustment path 10 of the valve plate 3 between the closed position and the maximum open position, this is different in the exemplary embodiments outlined hereunder. In the variants outlined hereunder it is provided that only the valve rod 4 which is stiffer in terms of a deflection transverse to its longitudinal extent is driven by its valve drive 6 in a linearly displaceable manner on the entire adjustment path 10 of the valve plate 3 between the closed position and the maximum open position. In the exemplary embodiments outlined hereunder, the valve rod 5 which is less stiff in terms of its deflection transverse to its longitudinal extent is driven by its valve drive 7 in a linearly displaceable manner only on a partial distance 11 of the adjustment path 10 of the valve plate 3 toward the closed position and/or away from the closed position. On the remaining other partial distance 12 of the adjustment path 10, the valve rod 5 which is less stiff in terms of its deflection transverse to its longitudinal extent is decoupled from its valve drive 7 in all variants of embodiment outlined hereunder.

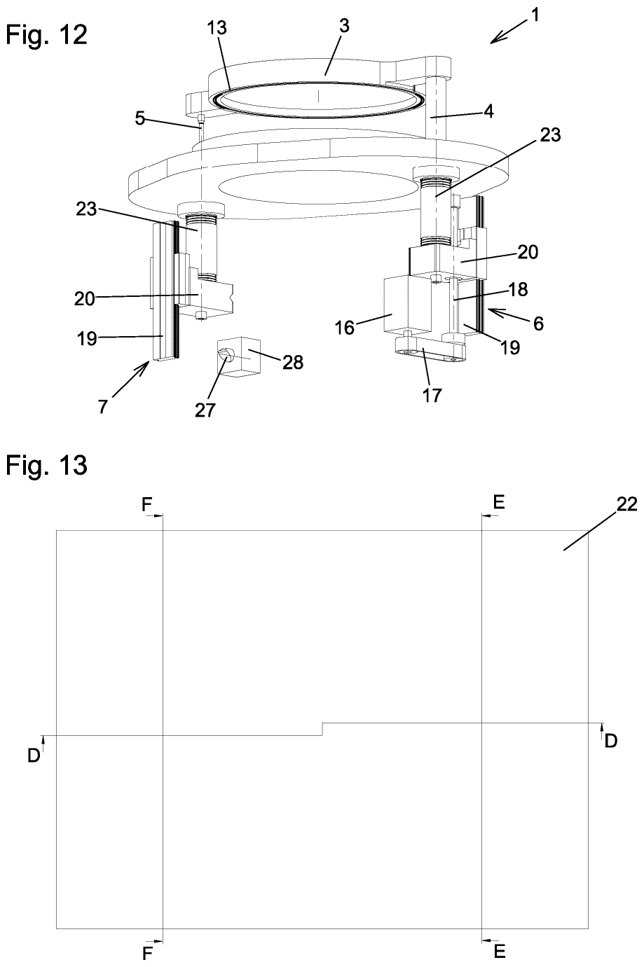

The second exemplary embodiment of the invention is shown in FIGS. 12 to 22. In the description hereunder of this second exemplary embodiment and the exemplary embodiments that are described thereafter, only the differences in comparison to the first exemplary embodiment will be discussed. Otherwise, reference is made to the above explanations pertaining to the first exemplary embodiment, which are to be applied in an analogous manner to the second and the following exemplary embodiments.

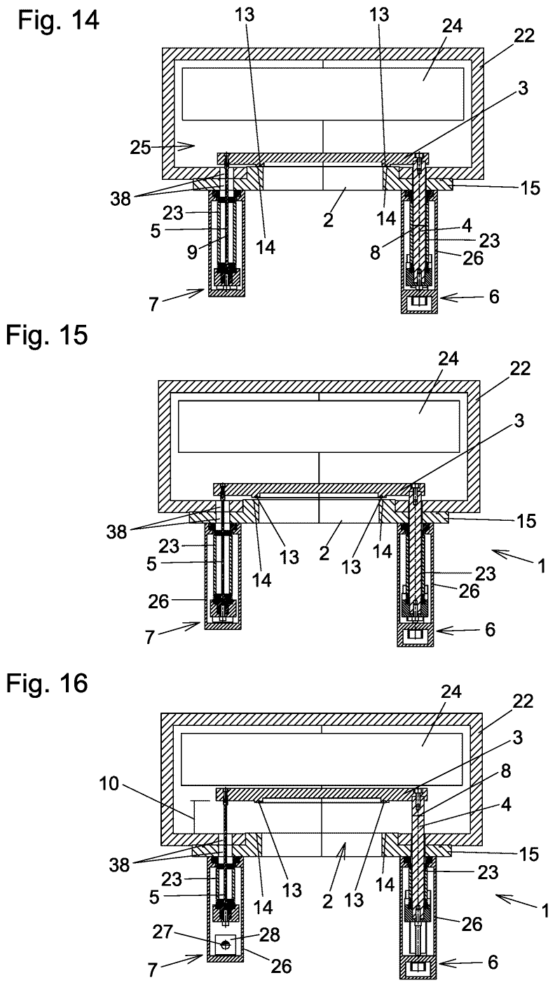

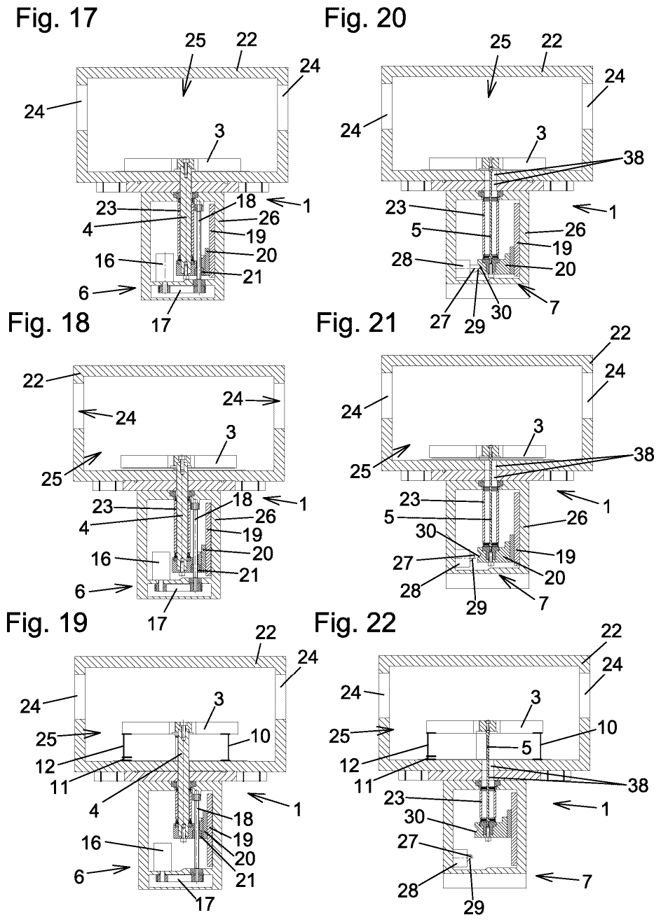

FIG. 12 shows the valve 1 of the second exemplary embodiment again detached from the process chamber 22, in a perspective illustration. FIG. 13 shows a top view, corresponding to FIG. 2, of the process chamber 22 with the section lines DD, EE and FF. FIGS. 14 to 16 again show sectional illustrations along the section line DD, wherein the valve plate 3 is in the closed position in FIG. 14, in an intermediate position in FIG. 15, and in the maximum open position in FIG. 16. FIGS. 17 to 19 show sections along the section line EE from FIG. 13, wherein FIG. 17 in turn shows the closed position, FIG. 18 an intermediate position, and FIG. 19 the maximum open position of the valve plate 3. Corresponding sections along the section line FF are shown in FIGS. 20 to 22. The valve plate 3 is again in the closed position in FIG. 20, in the intermediate position in FIG. 21, and in the maximum open position in FIG. 22.

The difference in comparison to the first exemplary embodiment can already be readily seen in FIG. 12. While the valve drive 6 of the stiffer valve rod 4 is designed as in the first exemplary embodiment, the valve drive 7 for the less stiff valve rod 5 is one which drives the less stiff valve rod 5 in a displaceable manner only on the partial distance 11 of the adjustment path 10 of the valve plate 3 toward the closed position. On the remaining partial distance 12 of the adjustment path 10, the valve rod 5 is decoupled from its valve drive 7. The decoupled state can be readily seen in FIGS. 12, 21 and 22. It is seen in FIG. 20 how the valve drive 7 engages in the slide 20 of the less stiff valve rod 5 and in this way, by means of traction on the less stiff valve rod 5 in the direction toward the closed position, presses the valve plate 3 against the valve seat 14.

In this second exemplary embodiment, the valve drive 7 has a drive pin 27 and a pin drive 28 which linearly displaces the latter. An oblique face 29, which in the coupled state presses against a mating oblique face 30 in the slide 20 of the less stiff valve rod 5, is located on the front end of the drive pin 27. By deploying the drive pin 27 by means of the pin drive 28, the valve rod 5 in the coupled state is thus also pulled in the direction toward the closed position of the valve plate 3. For opening, the drive pin 27 is retracted to such a degree that the latter releases the slide 20 in such a way that the valve plate 3 can then be moved to the intermediate position and also to the maximum open position exclusively by means of the stiffer valve rod 4 and the valve drive 6 of the latter.

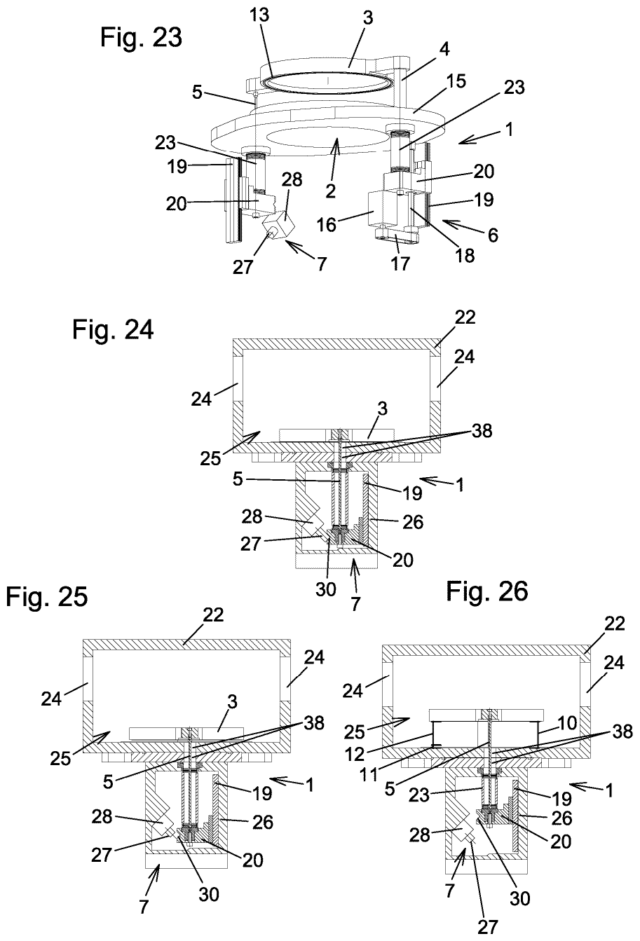

The third exemplary embodiment according to FIGS. 23 to 26 is a modified version of the second exemplary embodiment according to FIGS. 12 to 22, whereby FIG. 23 shows the illustration analogous to FIG. 12, and FIGS. 24 to 26 show the illustrations corresponding to FIGS. 20 to 22. In this third exemplary embodiment, the valve drive 7 of the less stiff valve rod 5 likewise has a drive pin 27 and a pin drive 28. However, the oblique face 29 on the front end of the drive pin is dispensed with here. Instead, the direction of movement and the longitudinal extent of the drive pin 27 is disposed so as to be correspondingly oblique in such a way that, as shown in FIG. 24, a displacement of the less stiff valve rod 5 is again performed by pressing the drive pin 27 against the mating oblique face 30 in the slide 20 of the less stiff valve rod 5, so that the valve plate 3 also in this example is moved in the direction toward the valve seat 14 and pressed against the latter by both valve rods 4 and 5 on the partial distance 11. The displacement of the valve plate 3 in the opening direction is again performed, as shown in FIGS. 25 and 26, exclusively by means of the valve drive 6 and the stiffer valve rod 4. The less stiff valve rod 5 is decoupled from the valve drive 7 on this partial distance 12 of the entire adjustment path 10.

The valve drive 6 for the stiffer valve rod 4 is designed as in the first exemplary embodiment and will therefore not be explained once more. This also applies to the variants of embodiment still to be outlined hereunder.

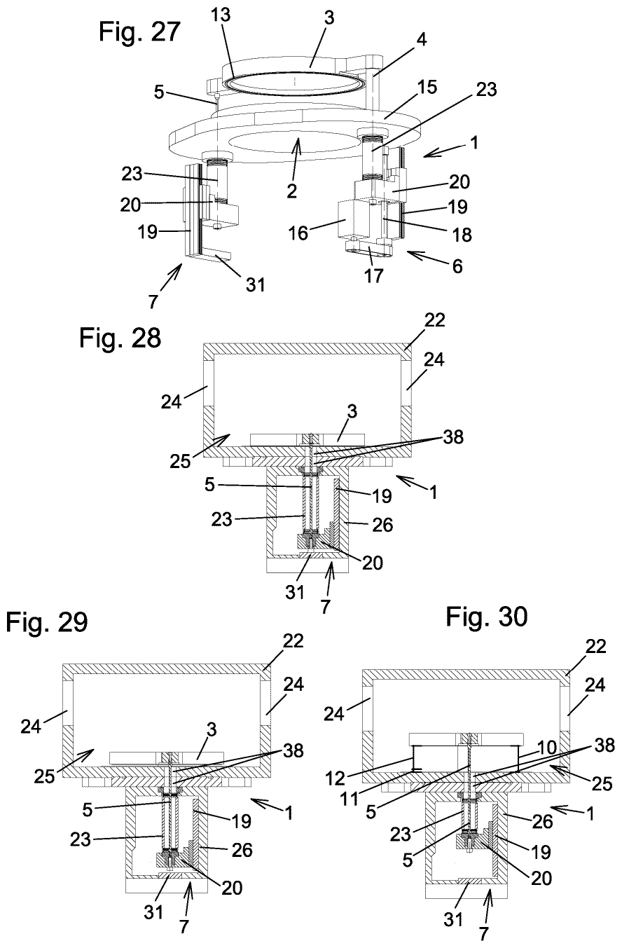

In the fourth exemplary embodiment, illustrated in FIGS. 27 to 30, the valve drive 7 for the less stiff valve rod 5 is designed in the form of a solenoid 31. The latter can be utilized for pulling the less stiff valve rod 5 downward on the partial distance 11, and thus pull the valve plate 3 to the closed position. By correspondingly reversing the polarity, the solenoid 31 can however also be utilized to drive the valve rod 5 on the partial distance 11 in the direction toward the opening position when opening the valve plate 3. Otherwise, this fourth exemplary embodiment is embodied like the third exemplary embodiment so that further explanations are unnecessary. In any case, FIG. 27 again shows a perspective illustration, and FIGS. 28 to 30 show the illustrations corresponding to FIGS. 20 to 22 of the second exemplary embodiment.

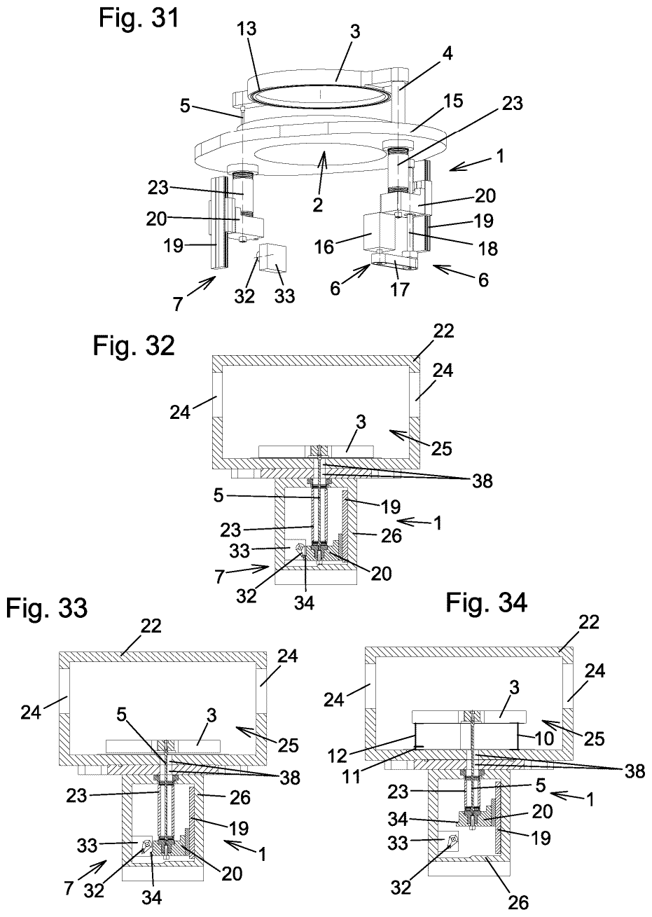

The fifth exemplary embodiment according to FIGS. 31 to 34 again differs from the second, third and fourth exemplary embodiment only in terms of the design embodiment of the valve drive 7 for the less stiff valve rod 5. The valve drive 7 here has a cam 32 which is pivotable by means of a cam drive 33 and which on the partial distance 11 engages in the gate guide 34 on the slide 20 so as to pull the valve rod 5, and thus also the valve plate 3, to the closed position. This can be seen in FIG. 32. FIGS. 33 and 34 show positions in which the cam 32 is released from the gate guide 34 and the valve rod 5 is thus uncoupled from the valve drive 7. Also in this variant, the valve drive 7 substantially serves to pull the valve rod 5 on the last partial distance 11 in the direction of the closed position of the valve plate 3. All other movements are implemented by means of the stiffer valve rod 4 and the valve drive 6 of the latter.

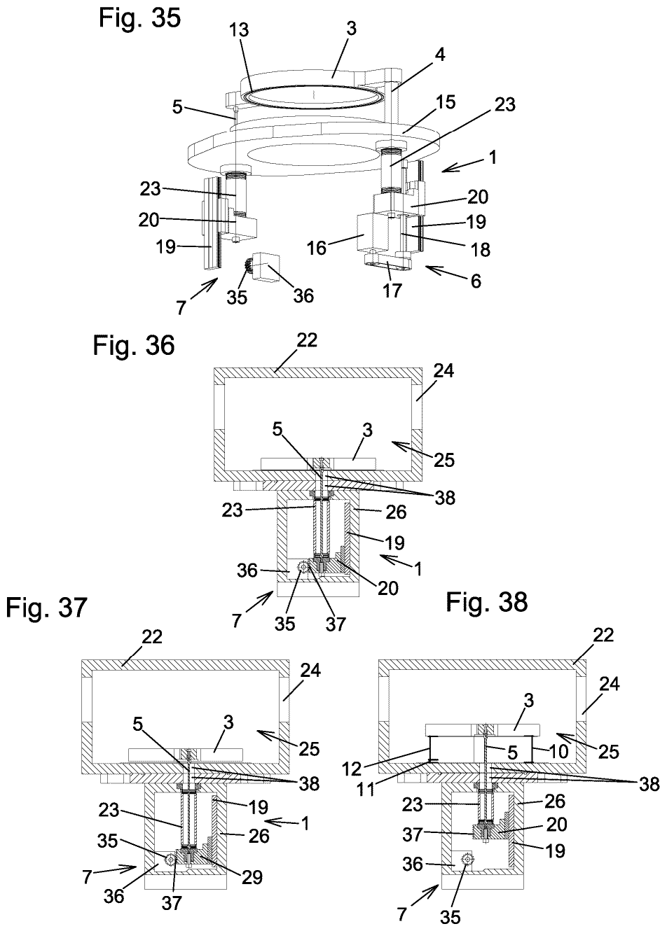

In the last exemplary embodiment according to FIGS. 35 to 38, corresponding illustrations are again shown. Here, the valve drive 7 for the less stiff valve rod 5 has a pinion 35 which is driven by means of a pinion drive 36. Said pinion on the lower partial distance 11 engages in a rack 37 on the slide 20 of the less stiff valve rod 5. As a result, the less stiff valve rod 5 can be driven in the direction toward the closed position of the valve plate 3, but on the partial distance 11 also driven in the opposite direction away from the closed position. Here too, the remaining movements on the partial distance 12 are implemented solely by means of the stiffer valve rod 4 and the valve drive 6 of the latter. The types of illustrations in FIGS. 35 to 38 are chosen so as to correspond to the previously discussed exemplary embodiments.

### LIST OF REFERENCE SIGNS

1 Valve
2 Flow opening
3 Valve plate
4 Valve rod
5 Valve rod
6 Valve drive
7 Valve drive
8 Diameter
9 Diameter
10 Entire adjustment path
11 Partial distance
12 Partial distance
13 Seal
14 Valve seat
15 Valve seat plate
16 Motor
17 Drive belt
18 Spindle
19 Guide rail
20 Slide
21 Spindle nut
22 Process chamber
23 Rod seal
24 Introduction opening
25 Chamber interior
26 Drive housing
27 Drive pin
28 Pin drive
29 Oblique face
30 Mating oblique face
31 Solenoid
32 Cam
33 Cam drive
34 Gate guide
35 Pinion
36 Pinion drive
37 Rack
38 Feedthrough

1. A valve for metering a volumetric flow through a flow opening, the valve comprising:
a valve plate for closing the flow opening in a closed position of the valve; and
at least two valve rods which are in each case inherently elongate, wherein the valve rods are being fastened to the valve plate at mutually spaced-apart locations, and at least one of the valve rods is driven in a linearly displaceable manner by a valve drive, so as to adjust the valve plate between the closed position and a maximum open position, and wherein the valve rods are designed with a different stiffness relative to one another in terms of a deflection transverse to a respective longitudinal extent of the valve rods.

2. The valve as claimed in claim 1, wherein the valve rods are formed from a same material.

3. The valve as claimed in claim 1, wherein the valve rods at least in regions have a different diameter relative to one another.

4. The valve as claimed in claim 1, wherein the valve rod which is stiffer in terms of the deflection transverse to the longitudinal extent thereof has a section modulus that is at least five times that of the other valve rod.

5. The valve as claimed in claim 1, further comprising a respective dedicated valve drive for each of the valve rods is driven by a dedicated valve drive of the valve.

6. The valve as claimed in claim 5, wherein the valve drives of the valve rods are mutually synchronized.

7. The valve as claimed in claim 5, wherein each of the valve rods is linearly driven by the respective valve drive over an entire adjustment path of the valve plate between the closed position and the maximum open position.

8. The valve as claimed in claim 5, wherein only the valve rod which is stiffer in terms of the deflection transverse to the longitudinal extent thereof is linearly driven by the respective valve drive over an entire adjustment path of the valve plate between the closed position and the maximum open position.

9. The valve as claimed in claim 8, wherein the valve rod which is less stiff in terms of the deflection transverse to the longitudinal extent thereof is linearly driven by the respective valve drive only over a partial distance of the adjustment path of the valve plate toward the closed position and away from the closed position.

10. The valve as claimed in claim 9, wherein the valve rod which is less stiff in terms of the deflection transverse to the longitudinal extent thereof is decoupled from the valve drive for a partial distance of the adjustment path of the valve plate toward the maximum open position and away from the maximum open position.
